(19) United States
(12) Patent Application Publication
(10) Pub. No.: US 2026/0024283 A1
(43) Pub. Date: Jan. 22, 2026

(54) INFORMATION PROCESSING DEVICE, INFORMATION PROCESSING METHOD, AND PROGRAM

(71) Applicant: SONY GROUP CORPORATION, TOKYO (JP)

(72) Inventor: TOMU TAHARA, TOKYO (JP)

(21) Appl. No.: 18/865,721

(22) PCT Filed: May 8, 2023
(86) PCT No.: PCT/JP2023/017328

§ 371 Date: Nov. 14, 2024

(30) Foreign Application Priority Data
May 23, 2022 (JP) 2022-083507

(51) Int. Cl. G06T 19/00

(52) U.S. Cl. CPC G06T 19/003

(57) ABSTRACT

The present technology relates to an information processing device, an information processing method, and a program enabling to automatically and efficiently set a virtual camera viewpoint for a virtual space to be used for rendering teacher CG image data.

An information processing device according to one aspect of the present technology generates a virtual viewpoint path that is a path including a plurality of viewpoints of a virtual camera, on the basis of context information of a space represented by a three-dimensional scene graph, and performs rendering of a virtual space at each viewpoint included in the virtual viewpoint path to generate teacher image data to be used for learning of a machine learning model. The present technology can be applied to a device having a function of a 3DCG simulator.

### TECHNICAL FIELD

The present technology particularly relates to an information processing device, an information processing method, and a program capable of automatically and efficiently setting a virtual camera viewpoint for a virtual space to be used for rendering teacher CG image data.

### BACKGROUND ART

Examples of an image processing task using a machine learning model include an image recognition task, a segmentation (e.g., semantic segmentation, instance segmentation, panoptic segmentation) task, and the like. In a case of performing such a task, it is necessary to prepare teacher image data in advance to perform learning of the machine learning model.

Normally, each piece of image data of a teacher image data group is generated by measuring (capturing an image of) a real space with a sensor such as a camera, and assigning (annotating) label information such as information regarding a subject appearing in the real image.

For the measurement of the real image and the annotation, a huge cost is required. Therefore, a technique of generating a large amount of CG image data serving as teacher image data by generating a CG model of an assumed space, assigning label information, setting a virtual camera viewpoint, and performing rendering has been proposed. In order to generate the CG model of a target space, a 3 dimensional computer graphics (3DCG) simulator such as a game engine is used.

Furthermore, a technology related to a method of arranging a virtual camera for generating CG image data to be used for learning has been proposed. For example, Patent Document 1 describes a technology of arranging a virtual camera so as to match a displacement of an actual depth camera with a displacement of an external parameter (translation, rotation) of the virtual camera.

Furthermore, Patent Document 2 describes a technology for determining a virtual camera viewpoint by aligning a real space and a virtual space of a 3D simulator and tracking a real camera.

### CITATION LIST

### Patent Document

Patent Document 1: Japanese Patent Application Laid-Open No. 2021-39563

Patent Document 2: International Publication No. 2020/067204

### SUMMARY OF THE INVENTION

### Problems to Be Solved by the Invention

Here, it is considered to set a virtual camera viewpoint for rendering so as to simulate a camera viewpoint corresponding to a measurement scenario of an image given as an input of an image processing task.

In order to achieve the setting of the virtual camera viewpoint according to an actual measurement scenario by the above-described technology, the real space and the virtual space geometrically need to match each other. A virtual camera viewpoint cannot be set for a virtual space that is not geometrically matched.

The present technology has been made in view of such a situation, and makes it possible to automatically and efficiently set a virtual camera viewpoint for a virtual space to be used for rendering teacher CG image data.

### Solutions to Problems

An information processing device according to one aspect of the present technology includes: a generation unit configured to generate a virtual viewpoint path that is a path including a plurality of viewpoints of a virtual camera on the basis of context information of a space, the context information being represented by a three-dimensional scene graph; and a rendering unit configured to perform rendering of a virtual space at each viewpoint included in the virtual viewpoint path, to generate teacher image data to be used for learning of a machine learning model.

In one aspect of the present technology, a virtual viewpoint path that is a path including a plurality of viewpoints of a virtual camera is generated on the basis of context information of a space represented by a three-dimensional scene graph. Furthermore, by rendering a virtual space at each viewpoint included in the virtual viewpoint path, teacher image data to be used for learning of a machine learning model is generated.

### BRIEF DESCRIPTION OF DRAWINGS

FIG. 1 is a diagram illustrating an example of processing of an information processing system according to an embodiment of the present technology.

FIG. 2 is a block diagram illustrating a configuration example of the information processing system.

FIG. 3 is a diagram illustrating an example of a scene graph.

FIG. 4 is a flowchart for explaining a series of processing of the information processing system.

FIG. 5 is a diagram illustrating an example of a measurement scenario in a task space.

FIG. 6 is a diagram illustrating an example of a three-dimensional scene graph of a task space and a camera viewpoint path.

FIG. 7 is a diagram illustrating an example of a three-dimensional scene graph for each anchor point.

FIG. 8 is a diagram illustrating an example of a three-dimensional scene graph for each anchor point.

FIG. 9 is a diagram illustrating an example of a three- dimensional scene graph for each anchor point.

FIG. 10 is a diagram illustrating an example of a three-dimensional scene graph of a virtual space.

FIG. 11 is a flowchart illustrating a detailed flow of generation of a virtual camera viewpoint path.

FIG. 12 is a diagram illustrating an example of comparison between three-dimensional scene graphs.

FIG. 13 is a diagram illustrating an example of generation of a virtual camera viewpoint path.

FIG. 14 is a flowchart for explaining another processing of the information processing system.

FIG. 15 is a block diagram illustrating a configuration example of a computer.

### MODE FOR CARRYING OUT THE INVENTION

Hereinafter, modes for carrying out the present technology will be described. The description will be given in the following order.
1. Overview of present technology
2. System configuration
3. Processing flow
4. Modification

### Overview of Present Technology

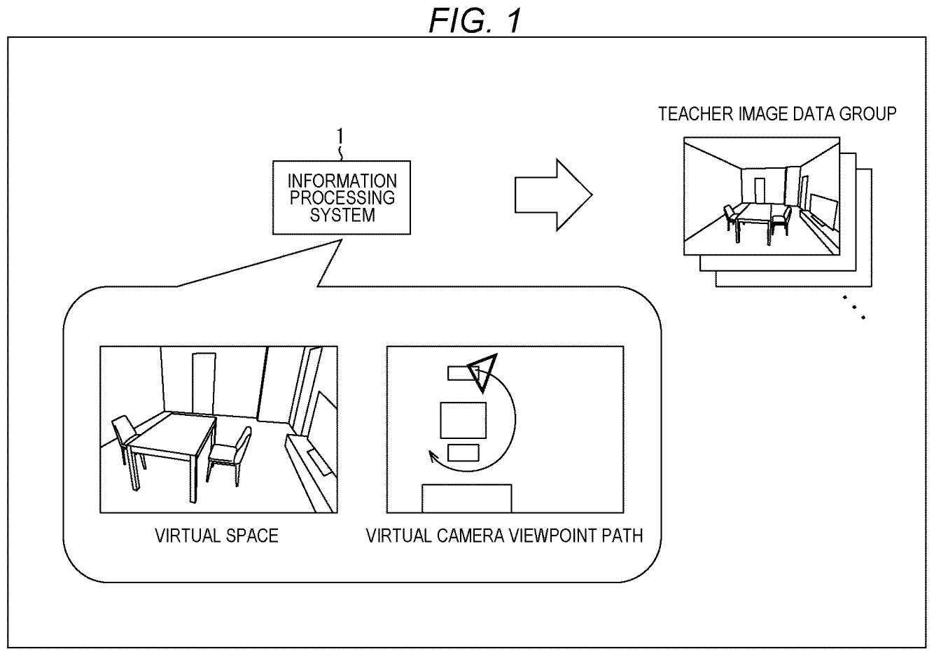

FIG. 1 is a diagram illustrating an example of processing of an information processing system according to an embodiment of the present technology.

An information processing system 1 of FIG. 1 is a system that generates, by using a 3DCG simulator, teacher image data to be used for learning of a machine learning model.

As illustrated in a balloon of FIG. 1, in the information processing system 1, a virtual space configured as 3D data is generated using the 3DCG simulator.

Furthermore, a virtual camera viewpoint path is set for the virtual space, and rendering is performed at each viewpoint on the virtual camera viewpoint path, whereby CG image data constituting the teacher image data is generated. The CG image data is image data in which an object (virtual object) or the like arranged in the virtual space appears as a subject.

The virtual camera viewpoint path is a path including an arrangement of viewpoints indicating a rendering position and an orientation of the virtual space. A plurality of virtual camera viewpoints, which is viewpoints of the virtual camera, is set, and the virtual camera viewpoint path is formed by the plurality of virtual camera viewpoints. In the example of FIG. 1, a virtual camera viewpoint path for moving around a table and a chair arranged in the virtual space is set.

Processing of the information processing system 1 is processing for adaptively setting the virtual camera viewpoint path according to an actual measurement scenario for various virtual spaces in order to generate teacher image data.

Specifically, the following processing is mainly performed.
A correspondence is acquired between context information of a virtual space and context information of a real space (hereinafter, referred to as a task space as appropriate) assumed by an image processing task using a machine learning model, and an actual camera viewpoint in the task space is adaptively converted as a virtual camera viewpoint in the virtual space.
Context information of a space is described using an abstract graph representation representing a relative relationship of objects present in the space. The context information of the space is represented on the basis of geometric and semantic information of objects present in the space, a relative relationship between the objects, and the like. The context information of the task space is acquired by measurement in advance. Whereas, the context information of the virtual space is acquired on the basis of information about a virtual object arranged on the 3DCG simulator or the like.
A camera viewpoint path which is a viewpoint path of an actual camera in the task space is subjected to conditioning on the basis of the context information of the task space and a measurement scenario. The measurement scenario is defined by the user. The virtual camera viewpoint is adaptively set by comparing the context information of the virtual space with the context information set as the condition of the camera viewpoint path, by using the three-dimensional scene graph and selecting a viewpoint corresponding to each camera viewpoint included in the camera viewpoint path.

Even when the task space and the virtual space do not geometrically coincide with each other, and the camera viewpoint of the task space cannot be directly used as the virtual camera viewpoint, the virtual camera viewpoint holding the context information and content of the measurement scenario is automatically set. The virtual camera viewpoint path formed on the basis of the virtual camera viewpoints set in this manner is a path on the virtual space corresponding to the camera viewpoint path on the task space.

### System Configuration

### <Configuration of Information Processing System>

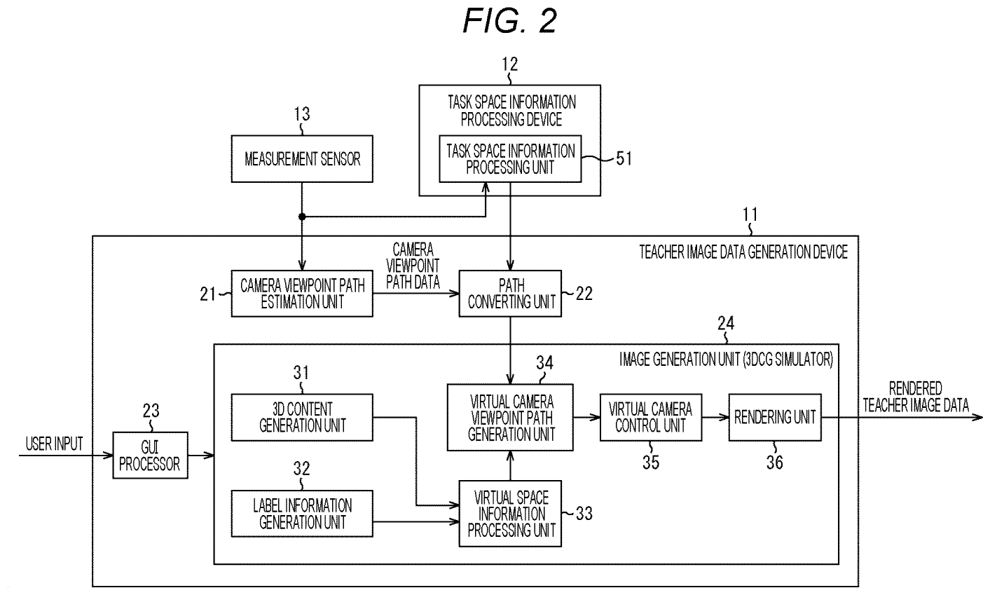

FIG. 2 is a block diagram illustrating a configuration example of the information processing system 1.

As illustrated in FIG. 2, the information processing system 1 includes a teacher image data generation device 11, a task space information processing device 12, and a measurement sensor 13.

Each of the teacher image data generation device 11 and the task space information processing device 12 includes an information processing device such as a PC, a tablet terminal, or a smartphone. The measurement sensor 13 is a sensor mounted on a device such as a camera, a depth sensor, or a smartphone.

The teacher image data generation device 11 includes a camera viewpoint path estimation unit 21, a path converting unit 22, a GUI processor 23, and an image generation unit 24. The image generation unit 24 is implemented by a 3DCG simulator such as a digital content creation tool or a game engine. The image generation unit 24 includes a 3D content generation unit 31, a label information generation unit 32, a virtual space information processing unit 33, a virtual camera viewpoint path generation unit 34, a virtual camera control unit 35, and a rendering unit 36.

In the task space information processing device 12, a task space information processing unit 51 is implemented.

At least some of the functional units illustrated in FIG. 2 are implemented when a CPU of a computer constituting the information processing device executes a predetermined program. A function of the task space information processing device 12 may be implemented in the teacher image data generation device 11, or the measurement sensor 13 may be provided in the teacher image data generation device 11.

Each functional unit of the teacher image data generation device 11 and the task space information processing device 12 will be described. Details will be appropriately described later.

### Task Space Information Processing Unit 51

The task space information processing unit 51 acquires geometric and semantic information of a task space which is a real space assumed by an image processing task. Furthermore, the task space information processing unit 51 acquires information indicating a relative relationship of individual units of the task space.

The task space information processing unit 51 generates a three-dimensional scene graph of the task space on the basis of the acquired information. The three-dimensional scene graph of the task space represents context information of the task space. In the generation of the three-dimensional scene graph, sensor data measured by the measurement sensor 13 is also used. The information of the three-dimensional scene graph generated by the task space information processing unit 51 is supplied to the path converting unit 22.

### Camera Viewpoint Path Estimation Unit 21

The camera viewpoint path estimation unit 21 estimates a camera viewpoint path on the basis of sensor data supplied from the measurement sensor 13. The camera viewpoint path estimation unit 21 functions as an estimation unit that estimates a camera viewpoint path, which is a path including a plurality of viewpoints on the task space.

As the sensor data, an RGB image acquired by an RGB camera, a distance image acquired by a depth sensor, point cloud data acquired by a distance measuring sensor such as LiDAR, or the like is supplied to the camera viewpoint path estimation unit 21.

Measurement using the measurement sensor 13 is performed according to a predetermined measurement scenario, by using, for example, a smartphone equipped with various sensors such as an RGB camera, a depth sensor, and a distance measurement sensor. For example, the user moves an own smartphone in accordance with the measurement scenario to perform measurement. Camera viewpoint path data which is information about a camera viewpoint path estimated by the camera viewpoint path estimation unit 21 is supplied to the path converting unit 22.

### Path Converting Unit 22

The path converting unit 22 performs conditioning on a camera viewpoint path estimated by the camera viewpoint path estimation unit 21, on the basis of a three-dimensional scene graph of a task space supplied from the task space information processing unit 51. The conditioning by the path converting unit 22 may be performed simultaneously with processing by the task space information processing unit 51. Information about the camera viewpoint path subjected to the conditioning by the path converting unit 22 is supplied to the virtual camera viewpoint path generation unit 34.

### GUI Processor 23

The GUI processor 23 controls an interface for a user. For example, the GUI processor 23 causes a display (not illustrated) to display a screen of the 3DCG simulator to receive a user's operation. Information indicating content of the user's operation is supplied to each unit of the image generation unit 24.

### 3D Content Generation Unit 31

The 3D content generation unit 31 generates 3D content, which is content using a virtual space, in accordance with a user's operation on the 3DCG simulator. In the virtual space, a virtual object is arranged according to an operation by the user. Data of the 3D content generated by the 3D content generation unit 31 is supplied to the virtual space information processing unit 33.

### Label Information Generation Unit 32

The label information generation unit 32 assigns label information of an image processing task to each virtual object. The label information assigned by the label information generation unit 32 is supplied to the virtual space information processing unit 33.

### Virtual Space Information Processing Unit 33

The virtual space information processing unit 33 generates a three-dimensional scene graph of a virtual space on the basis of geometric and semantic information and the like of the 3D content generated by the 3D content generation unit 31. The label information generated by the label information generation unit 32 is appropriately used to generate a three-dimensional scene graph representing context information of the virtual space. Information about the three-dimensional scene graph generated by the virtual space information processing unit 33 is supplied to the virtual camera viewpoint path generation unit 34.

### Virtual Camera Viewpoint Path Generation Unit 34

The virtual camera viewpoint path generation unit 34 compares the three-dimensional scene graph of the camera viewpoint path subjected to conditioning by the path converting unit 22 with the three-dimensional scene graph of the virtual space generated by the virtual space information processing unit 33, and acquires a correspondence between the task space and the virtual space.

On the basis of the correspondence between the task space and the virtual space, the virtual camera viewpoint path generation unit 34 adapts a camera viewpoint path in the task space to the virtual space, and generates a virtual camera viewpoint path. Information about the virtual camera viewpoint path generated by the virtual camera viewpoint path generation unit 34 is supplied to the virtual camera control unit 35.

The conditioning on the camera viewpoint path is performed using the context information of the task space as described above. The virtual camera viewpoint path is generated by the virtual camera viewpoint path generation unit 34, on the basis of the context information of the task space and the context information of the virtual space that are represented by the three-dimensional scene graphs.

### Virtual Camera Control Unit 35

The virtual camera control unit 35 sets a virtual camera in the virtual space on the basis of the virtual camera viewpoint path generated by the virtual camera viewpoint path generation unit 34. The virtual camera is set for a virtual camera viewpoint included in the virtual camera viewpoint path and corresponding to each time.

Furthermore, the virtual camera control unit 35 appropriately adjusts the virtual camera viewpoint in accordance with an operation by the user. Information indicating setting content of the virtual camera by the virtual camera control unit 35 is supplied to the rendering unit 36.

### Rendering Unit 36

The rendering unit 36 performs rendering according to the virtual camera set by the virtual camera control unit 35, to generate teacher image data. The teacher image data generated by the rendering unit 36 is supplied to, for example, an external device that performs learning of a machine learning model.

### <Abstract Description of Context Information by Three-Dimensional Scene Graph>

Here, an abstract description of context information of a space by a three-dimensional scene graph will be described.

The context information of the space is defined by the space, geometric information such as a three-dimensional shape, the number, a position, and an orientation of objects present in the space, semantic information such as attributes of individual objects, and a relative relationship thereof. The attributes of the object include a category, an ID, a material, a color, an affordance, and the like of the object.

As described in Document 1, the context information of the space can be abstractly described as a three-dimensional scene graph on the basis of these pieces of information.

Document 1 “Tahara et al., Retargetable AR: Context-aware Augmented Reality in Indoor Scenes based on 3D Scene Graph, 2020 IEEE International Symposium on Mixed and Augmented Reality Adjunct (ISMAR-Adjunct)”

The three-dimensional scene graph is data having a graph structure in which an object present in a space is represented as a node and a relationship between nodes is represented using an edge. A part of an object present in the space, a user in the space, a virtual character arranged in the space, and the like are also appropriately represented as nodes.

A relationship between the nodes is represented using description in a natural language. For example, when there is a chair and a table in the space and the chair and the table are arranged close to each other, a node of the chair and a node of the table are connected by an edge having a label “near”.

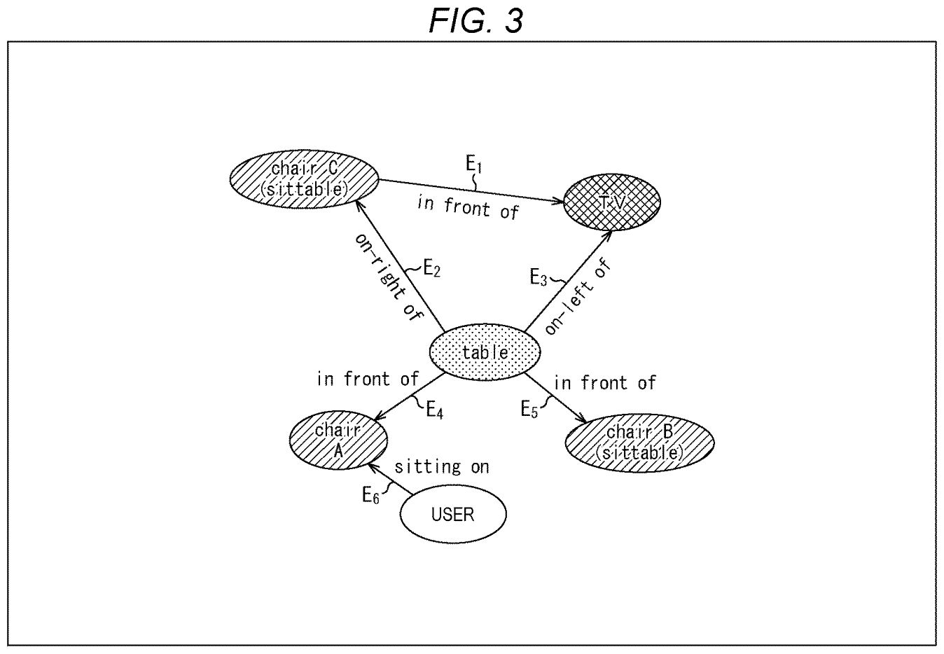

FIG. 3 is a diagram illustrating an example of a scene graph.

For example, when a table, a television, and chairs A to C are present in a task space and are arranged so as to have a predetermined positional relationship, as illustrated in FIG. 3, the scene graph of the task space is formed using six nodes representing these objects (real objects) and a user. In the example of FIG. 3, the user in the space is represented as a node.

In the example of FIG. 3, the node of the chair C and the node of the television are connected by an edge E₁ having a label “in front of”. The label of the edge E₁ represents that the chair C is present in front of the television.

Furthermore, the node of the chair C and the node of the table are connected by an edge E₂ having a label “on-right of”. The label of the edge E₂ represents that the table is on the right side of the chair C.

The node of the television and the node of the table are connected by an edge E₃ having a label of “on-left of”. The label of the edge E₃ indicates that the table is on the left side of the television.

The node of the table and the node of the chair A and the edge connecting the node of the table and the node of the chair B are also connected by edges E₄ and E₅ in which labels indicating positional relationships therebetween are set.

In the example of FIG. 3, the user sits on the chair A, which is represented by a label of an edge E₆ connecting the node of the chair A and the node of the user. In the edge E₆, a label “sitting on” indicating that the user is sitting on the chair A is set.

As described above, as the label set in the edge, a label indicating a spatial positional relationship (front/behind/left/right/on/above/under/near, . . . ), a label indicating an action performed by the user using the object, or the like is used. An action or an interaction (such as sitting (a person is sitting on a chair)) that the object or the user exerts on the space is also used as a relationship between nodes.

### Processing Flow

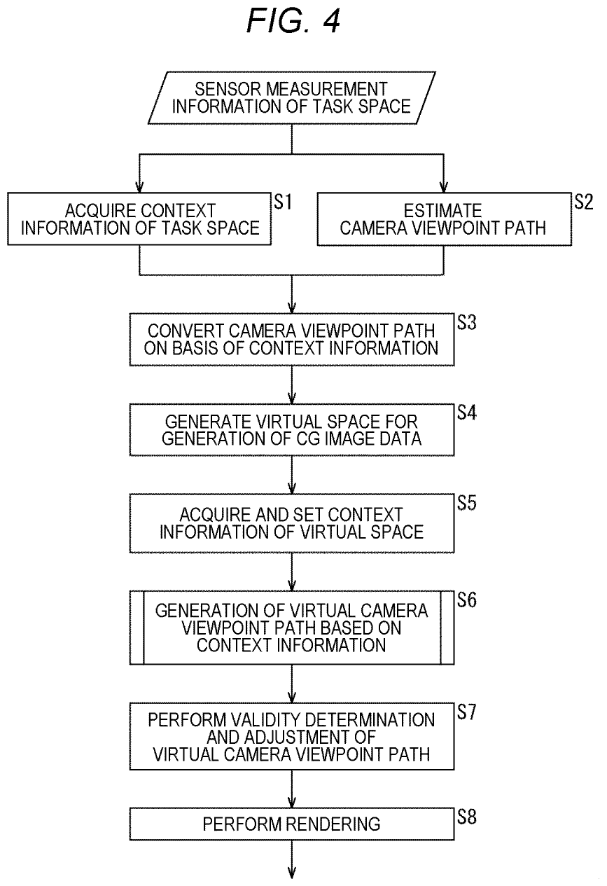

A series of processing of the information processing system 1 will be described with reference to the flowchart of FIG. 4. The processing of FIG. 4 is started, for example, when sensor data measured by the measurement sensor 13 is input to the camera viewpoint path estimation unit 21 and the task space information processing unit 51.

### <Step S1: Acquisition of Context Information of Task Space>

In step S1, the task space information processing unit 51 acquires context information of a task space, and generates a three-dimensional scene graph of the task space. When the task space is a real space, the context information is acquired by previously generating a three-dimensional map integrating geometric and semantic information of the space.

The three-dimensional map is generated on the basis of an RGB image acquired by an RGB camera, as the measurement sensor 13, a distance image acquired by a depth sensor, a point cloud measured by LiDAR, or the like. The generation of the three-dimensional map using a computer vision technology is described in Documents 2 and 3.

Document 2 “G. Narita et al. Panopticfusion: Online volumetric semantic mapping at the level of stuff and things. In IEEE/RSJ Int. Conf. on Intelligent Robots and Systems (IROS), 2019.”

Document 3 “J. Hou et al. 3D-SIS: 3D Semantic Instance Segmentation of RGB-D Scans. CVPR, 2019.”

For example, by using the three-dimensional map generated in advance, a relative relationship between real objects is estimated on the basis of a shape, a position, and an orientation of each real object in the task space, and a distance, a direction, and the like between the real objects. It is possible to generate the three-dimensional scene graph as described in Document 1 described above on the basis of a relative relationship between the real objects and the like. The relative relationship between the real objects may be determined on the basis of rules by using geometric and semantic information, or may be estimated using a neural network or the like.

In the present embodiment, a case is assumed in which the task space is a real space, but the present technology is also applicable to a case where an image processing task is executed in a virtual space different from a virtual space to be used for generating teacher image data. In this case, geometric and semantic information of the virtual space assumed by the task is acquired from a 3DCG simulator, and the three-dimensional scene graph is generated on the basis of the acquired information.

### <Step S2: Estimation of Camera Viewpoint Path>

In step S2, the camera viewpoint path estimation unit 21 estimates a camera viewpoint path in the task space. The camera viewpoint path estimated here is used in subsequent processing as conversion source information for a virtual camera viewpoint path.

The camera viewpoint path in the task space is estimated, for example, by performing simultaneous localization and mapping (SLAM) processing (visual SLAM processing) based on a still image or a moving image acquired by a camera as the measurement sensor 13. When the measurement sensor 13 includes a GPS sensor and an IMU, the camera viewpoint path may be estimated on the basis of position information, acceleration, and angular velocity information measured by these sensors. The camera viewpoint path is represented by time-series information of a position and an orientation of the camera according to a measurement scenario.

The camera viewpoint path in the task space may be estimated in a device outside the teacher image data generation device 11, such as a smartphone on which the measurement sensor 13 is mounted or a PC to which the measurement sensor 13 is connected.

### <Step S3: Conversion of Camera Viewpoint Path Based on Context Information>

In step S3, the path converting unit 22 converts the camera viewpoint path generated by the camera viewpoint path estimation unit 21 into a path subjected to conditioning, on the basis of the three-dimensional scene graph of the task space.

Specifically, the path converting unit 22 sets anchor points on the camera viewpoint path by sampling at any intervals such as key frame intervals.

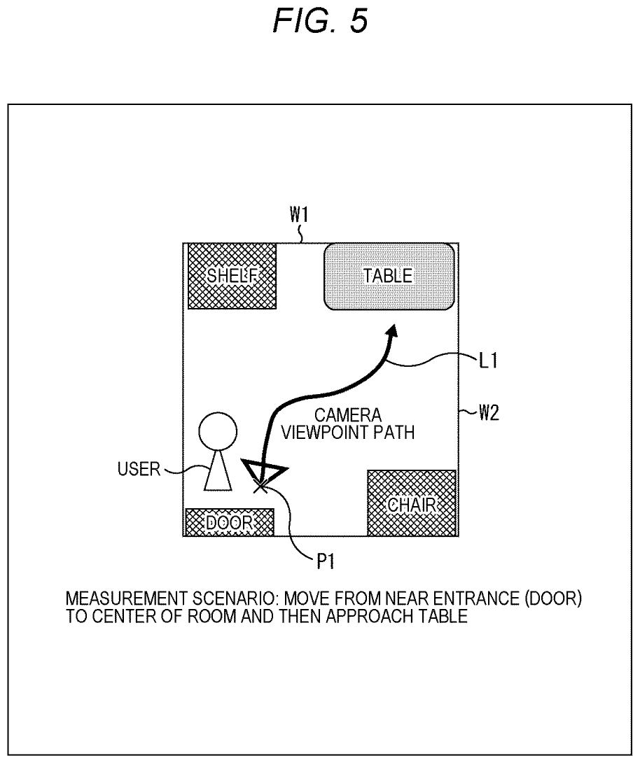

FIG. 5 is a diagram illustrating an example of the measurement scenario in the task space.

A door, a chair, a table, and a shelf are individually arranged near four corners of a room selected as a task space. The task space illustrated in FIG. 5 is a space having a substantially square shape in plan view. A triangle arranged at a position P1 indicates a position and an orientation of the camera. In the example of FIG. 5, the camera at the position P1 is directed in a direction of a wall W1 where the table and the shelf are located.

A case will be described in which a measurement scenario in such a task space is defined as “move from near the entrance (door) of the room to the center of the room and then approach the table”. The camera viewpoint path according to the measurement scenario is a path indicated by a curve L1.

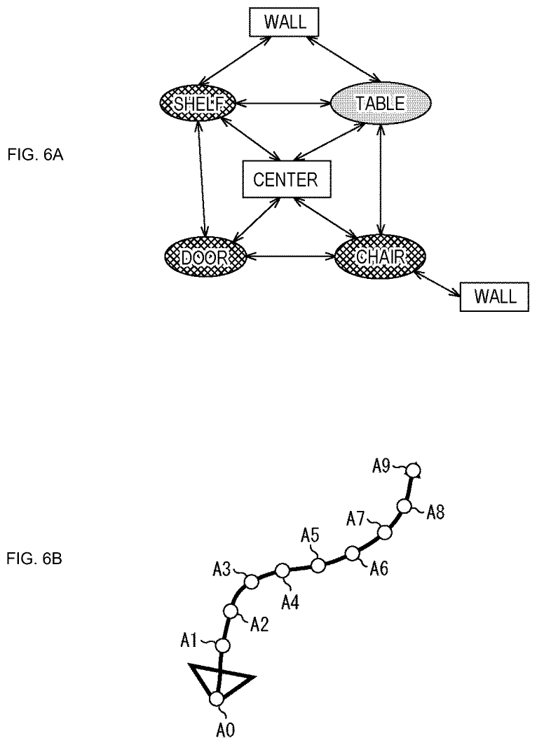

When the room in FIG. 5 is selected the a task space, as illustrated in A of FIG. 6, a three-dimensional scene graph of the task space is to be a graph in which individual nodes of the door, the chair, the table, and the shelf, nodes of walls of the room, and a node of a center of the room as a reference position are connected by edges. In A of FIG. 6, the node of the wall connected to the node of the shelf and the node of the table corresponds to the wall W1 of FIG. 5, and the node of the wall connected to the node of the chair corresponds to a wall W2 of FIG. 5. At least an object present in the task space is represented by a node.

When the camera viewpoint path according to the measurement scenario is represented by the curve L1, anchor points A0 to A9 are set on the camera viewpoint path as indicated by small circles in B of FIG. 6.

Furthermore, the path converting unit 22 generates a three-dimensional scene graph for each anchor point (for each time point of the measurement scenario). The three-dimensional scene graph for each anchor point is generated using the node of the camera and a node of a target object required to achieve the measurement scenario.

As the target object, “door”, “center of the room”, and “table” are used, which are included in the measurement scenario among objects and the like represented as nodes constituting the three-dimensional scene graph of the task space. That is, the three-dimensional scene graph representing the context information of each anchor point is generated for each anchor point of the camera viewpoint path, by using a part of the entire three-dimensional scene graph representing context information of the task space.

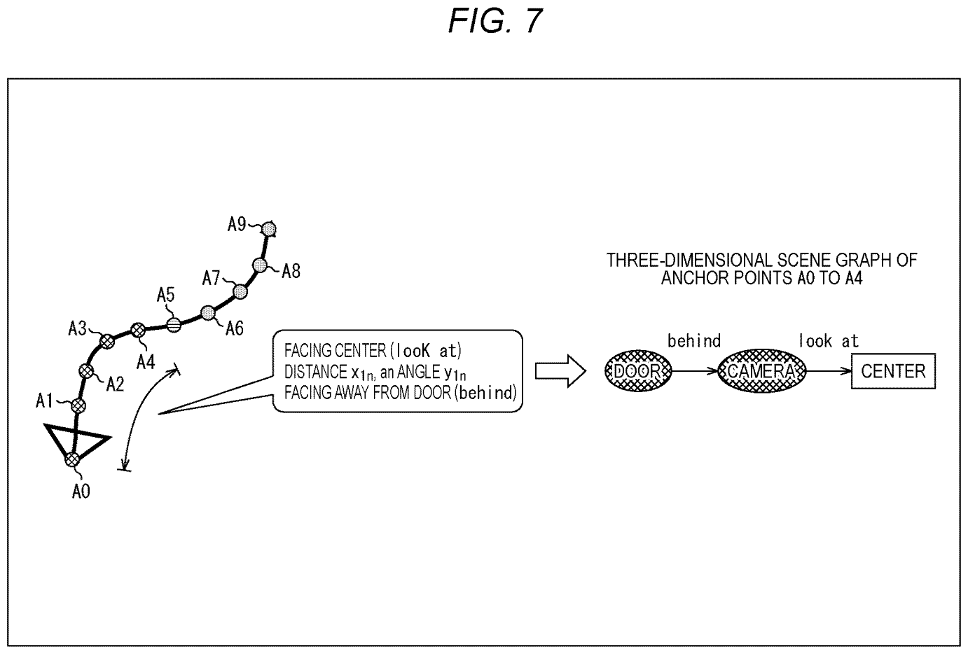

FIGS. 7 to 9 are diagrams illustrating examples of the three-dimensional scene graph for each anchor point.

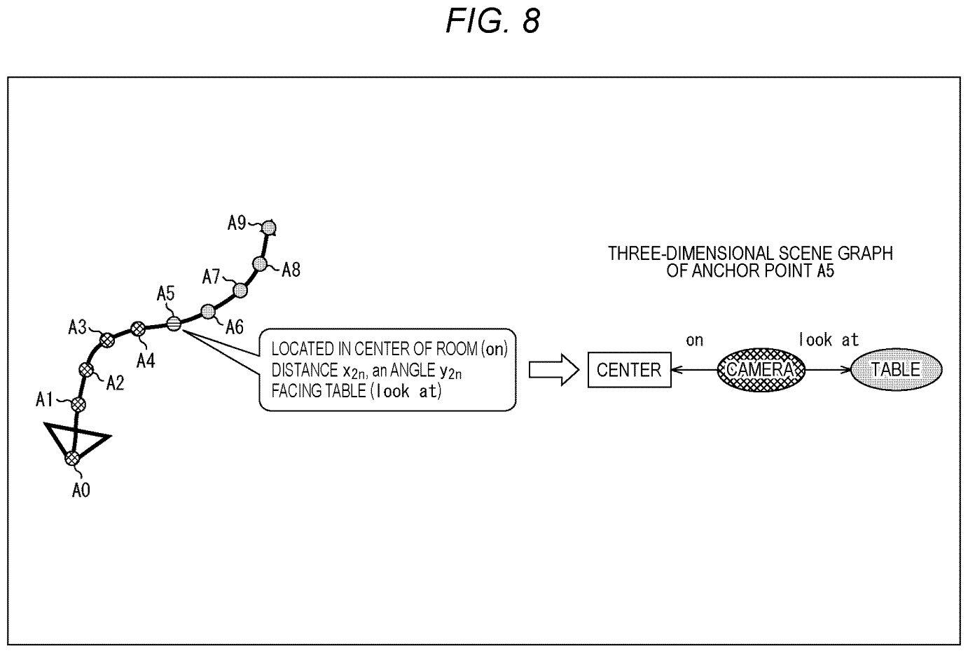

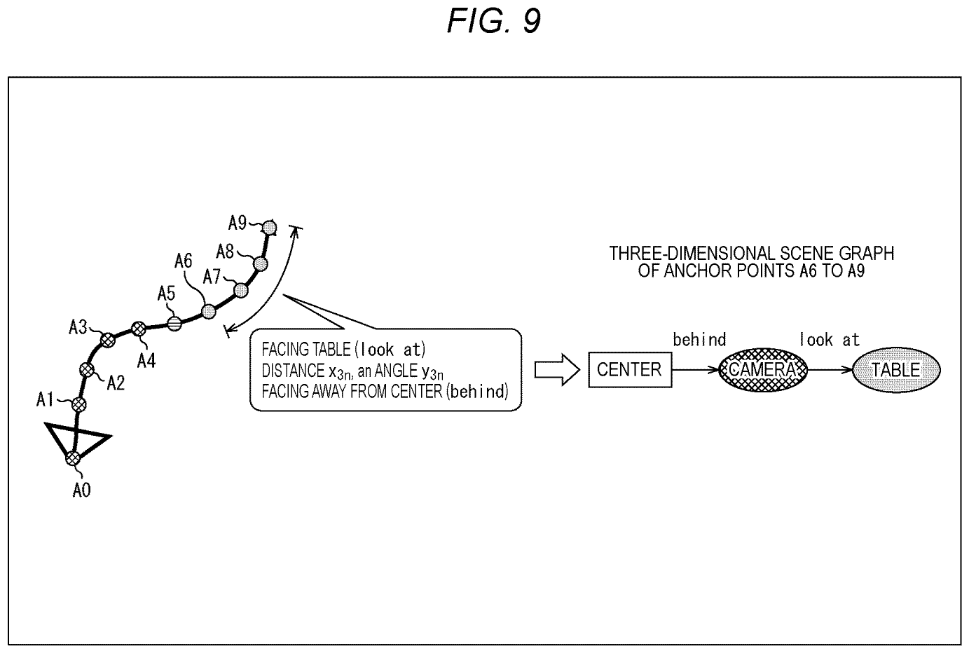

The following three types of three-dimensional scene graphs are generated in accordance with a temporal change of a relationship between the camera and the target object.
(1) The camera is facing the center of the room, and facing away from the entrance (door) (FIG. 7).
(2) The camera is located in the center of the room, and facing the table (FIG. 8).
(3) The camera is facing the table, and facing away from the center of the room (FIG. 9).

FIG. 7 illustrates a three-dimensional scene graph of each of the anchor points A0 to A4. As illustrated on the right side of FIG. 7, context information of each of the anchor points A0 to A4 is represented as a three-dimensional scene graph in which the node of the door and the node of the camera are connected by an edge having a label “behind”, and the node of the camera and the node of the center of the room are connected by an edge having a label “look at”.

FIG. 8 illustrates a three-dimensional scene graph of the anchor point A5. As illustrated on the right side of FIG. 8, context information of the anchor point A5 is represented as a three-dimensional scene graph in which the node of the center and the node of the camera are connected by an edge having a label “on”, and the node of the camera and the node of the table are connected by an edge having a label “look at”.

FIG. 9 illustrates a three-dimensional scene graph of each of the anchor points A6 to A9. As illustrated on the right side of FIG. 9, context information of each of the anchor points A6 to A9 is represented as a three-dimensional scene graph in which the node of the center and the node of the camera are connected by an edge having a label “behind”, and the node of the camera and the node of the table are connected by an edge having a label “look at”.

In this manner, the camera viewpoint path subjected to conditioning on the basis of the context information is generated by setting the three-dimensional scene graph to each anchor point sampled from the camera viewpoint path and corresponding to the camera viewpoint. The camera viewpoint path including the anchor point to which the three-dimensional scene graph is set is the camera viewpoint path subjected to conditioning on the basis of the context information.

Furthermore, from the three-dimensional map, the path converting unit 22 acquires a relative distance and angle between real objects, together with a relative relationship between the camera and the target object. On the basis of the acquired information, the path converting unit 22 adds information about a distance of the camera between with the target object and an angle of the camera with respect to the target object at each anchor point, to the three-dimensional scene graph.

For example, a distance xᵢₙ and an angle yᵢₙ illustrated in a balloon of FIG. 7 indicate, for example, a distance and an angle between the camera and the center of the room at the anchor point An (n=0 to 4). By adding information about a distance and an angle, it is possible to set a temporal anteroposterior relationship with respect to the anchor points A0 to A4 to which the three-dimensional scene graphs having the same graph structure are allocated.

### <Step S4: Generation of Virtual Space for Generation of CG Image Data>

In step S4 of FIG. 4, the 3D content generation unit 31 generates a virtual space to be used for generating CG image data.

The virtual space is generated using various 3DCG simulators such as a digital content creation tool and a game engine used for creation of virtual content such as CG videos and games. The virtual object is represented by a 3DCG model by CAD or the like, and is arranged in a virtual space. The virtual space may be generated by a designer or the like as a user.

Furthermore, in step S4, the label information generation unit 32 sets label information for each virtual object arranged in the virtual space. As meta information of the virtual object, label information that is a true value of a task is assigned (annotated) as necessary. The label information is automatically or manually assigned by using a function of the 3DCG simulator or using an additional program.

As a result, 3D content of the virtual space is generated in which the label information is assigned to the virtual object or the like. By setting and rendering any virtual camera viewpoint on the 3DCG simulator, it becomes possible to generate CG image data to be used for learning of a machine learning model for a target task and corresponding label image data. For example, teacher CG image data is formed by a pair of CG image data and corresponding label image data.

### <Step S5: Acquisition and Setting of Context Information of Virtual Space>

In step S5, the virtual space information processing unit 33 acquires geometric and semantic information of the 3D content, and generates a three-dimensional scene graph of the virtual space.

Context information of the virtual space is expressed using an abstract description as a three-dimensional scene graph, similarly to the context information of the task space. For example, the virtual space information processing unit 33 holds geometric and semantic information of the virtual space set on the 3DCG simulator at the time of generating the virtual space. Furthermore, the virtual space information processing unit 33 similarly holds geometric and semantic information of a virtual object arranged in the virtual space. The virtual space information processing unit 33 generates the three-dimensional scene graph of the virtual space on the basis of the held information.

### <Step S6: Generation of Virtual Camera Viewpoint Path Based on Context Information>

In step S6, the virtual camera viewpoint path generation unit 34 acquires a correspondence between the context information of the virtual space and context information set in a camera viewpoint path by performing conditioning. The virtual camera viewpoint path generation unit 34 generates a virtual camera viewpoint path according to a measurement scenario on the basis of the acquired correspondence.

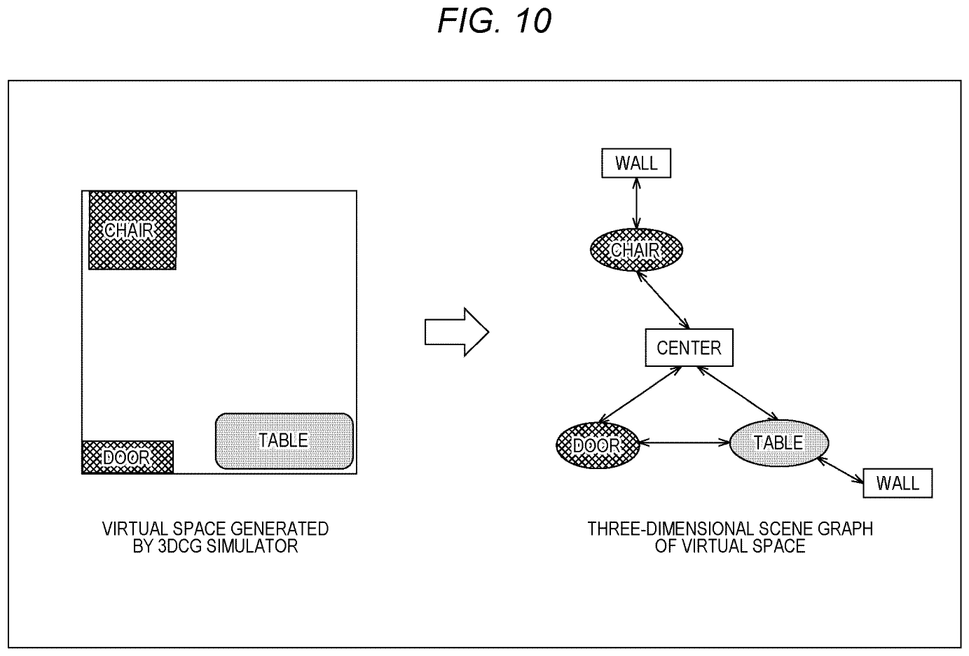

Here, as illustrated on the left side of FIG. 10, a case will be described in which a virtual space having a structure different from that of the task space is generated. A door, a chair, and a table are arranged individually at corners of a room serving as the virtual space. The task space and the virtual space are spaces having different context information.

When the room illustrated in FIG. 10 is generated as the virtual space, as illustrated on the right side of FIG. 10, a three-dimensional scene graph of the virtual space is represented as a graph in which individual nodes of the door, the chair, and the table, nodes of walls of the room, and a node of the center as a reference position are connected by edges. At least a virtual object arranged in the virtual space is represented by a node. The edges constituting the graph represent one or more relationships between nodes.

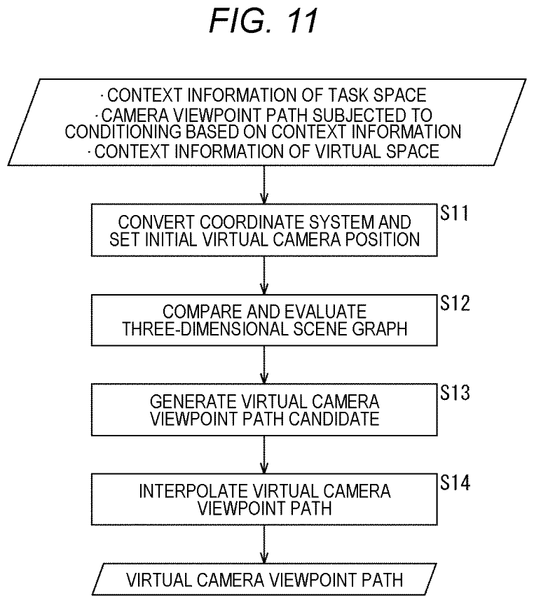

FIG. 11 is a flowchart illustrating a detailed flow of generation of the virtual camera viewpoint path.
Step 11: Coordinate system conversion and setting of initial virtual camera position
Step S12: Comparison and evaluation of three-dimensional scene graph
Step S13: Generation of virtual camera viewpoint path candidates
Step S14: Interpolation of virtual camera viewpoint path

In step S11, the virtual camera viewpoint path generation unit 34 converts a coordinate system of the task space into a coordinate system of the virtual space.

Furthermore, the virtual camera viewpoint path generation unit 34 sets an initial virtual camera position, which is an initial position of the virtual camera, on the virtual space on the basis of a camera viewpoint path in the task space. The camera viewpoint path to be used for setting the initial position of the virtual camera is a camera viewpoint path subjected to conditioning on the basis of the context information.

For example, the virtual camera viewpoint path generation unit 34 refers to a three-dimensional scene graph in the task space at the time of the initial position, and sets a corresponding position in the virtual space as the initial position of the virtual camera. With reference to the three-dimensional scene graph of the anchor point A0 (FIG. 7), a position in the virtual space close to the door is set as the initial position of the virtual camera.

In step S12, by comparing and evaluating the three-dimensional scene graph of the task space and the three-dimensional scene graph of the virtual space, the virtual camera viewpoint path generation unit 34 extracts context information shared by both spaces.

Here, the context information shared by both spaces is extracted by solving a partial graph isomorphic problem between the three-dimensional scene graphs. For example, when a partial graph including the target object in the measurement scenario is included in the three-dimensional scene graph of the virtual space, it is evaluated that the virtual camera viewpoint path can be generated.

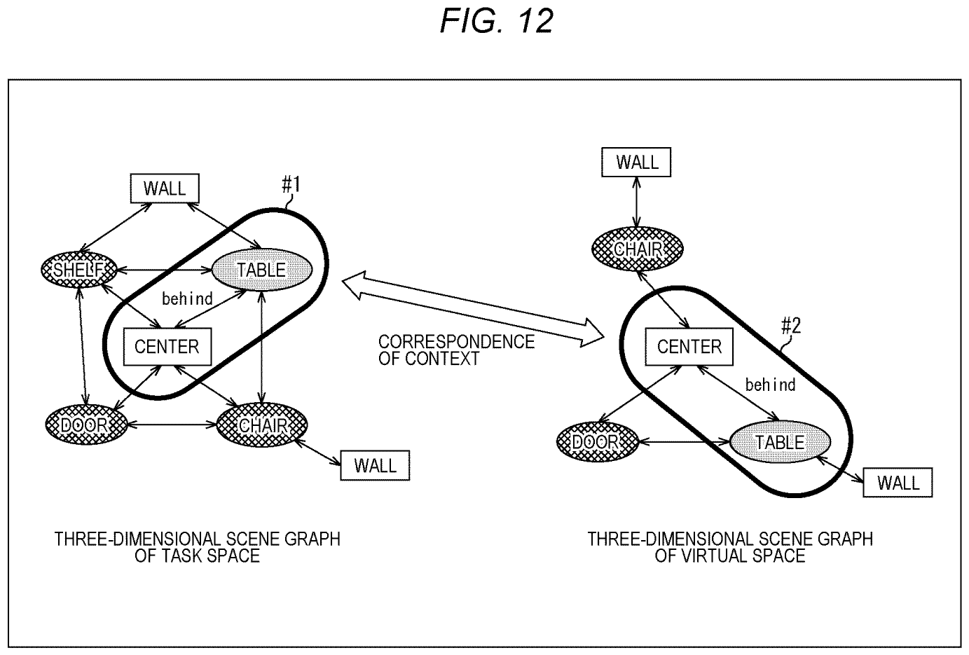

FIG. 12 is a diagram illustrating an example of comparison between three-dimensional scene graphs.

The left side of FIG. 12 illustrates the three-dimensional scene graph of the task space (A of FIG. 6), and the right side illustrates the three-dimensional scene graph of the virtual space (FIG. 10).

As illustrated by ellipse #1 in FIG. 12, when the target object in the measurement scenario is the “center of the room” and the “table”, a partial graph indicating context information indicating that there is a “behind” relationship between the “center of the room” and the “table” is acquired as a corresponding graph from the three-dimensional scene graph of the virtual space.

In the example of FIG. 12, a partial graph of the task space surrounded by ellipse #1 and a partial graph of the virtual space surrounded by ellipse #2 are acquired as corresponding graphs. Context information represented by the corresponding graph is the context information shared by both spaces.

In step S13 of FIG. 11, the virtual camera viewpoint path generation unit 34 sets a three-dimensional point group (anchor point group) to be the virtual camera viewpoint at each time point such that the three-dimensional scene graph in the virtual space representing a relative position and orientation of the target object and the virtual camera at each time point is common to the three-dimensional scene graph at each time point in the task space described with reference to FIGS. 7 to 9.

For example, a candidate for the virtual camera viewpoint may be presented to the user, and a candidate point selected by the user may be used as the virtual camera viewpoint. Furthermore, a cost is set in advance for an edge or the like of an important relationship in the three-dimensional scene graph, and optimization is performed to minimize a total sum of costs when each of the candidate three-dimensional points is selected, whereby a three-dimensional point group to be the virtual camera viewpoint is generated.

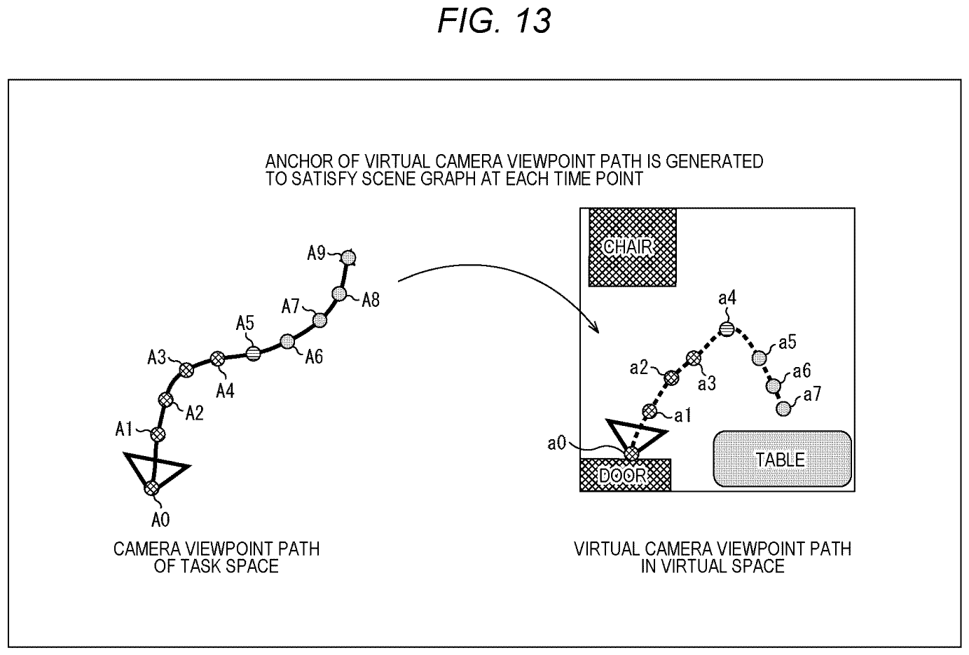

As a result, even when the task space and the virtual space have different structures, the virtual camera viewpoint path satisfying the measurement scenario of “move from near the entrance (door) of the room to the center of the room and then approach the table” is generated on the basis of the context information shared by both spaces as illustrated in FIG. 13.

In the example of FIG. 13, a path including anchor points a0 to a7 is set as a candidate for the virtual camera viewpoint path according to the measurement scenario. A position of the anchor point a0 is the initial position of the virtual camera set in step S11.

The three-dimensional scene graph at each time point of the anchor points a0 to a3 has, for example, the graph structure of FIG. 7 same as the three-dimensional scene graph at each time point of the anchor points A0 to A3. That is, context information of each of the anchor points a0 to a4 is represented as a three-dimensional scene graph in which the node of the door and the node of the virtual camera are connected by an edge having a label “behind”, and the node of the virtual camera and the node of the center of the room are connected by an edge having a label “look at”.

The three-dimensional scene graph at the time point of the anchor point a4 has, for example, the graph structure of FIG. 8 same as the three-dimensional scene graph at the time point of the anchor point A5. Context information of the anchor point a4 is represented as a three-dimensional scene graph in which the node of the center and the node of the virtual camera are connected by an edge having a label “on”, and the node of the virtual camera and the node of the table are connected by an edge having a label “look at”.

The three-dimensional scene graph at each time point of the anchor points a5 to a7 has, for example, the graph structure of FIG. 9 same as the three-dimensional scene graph at each time point of the anchor points A7 to A9. Context information of each of the anchor points a5 to a7 is represented as a three-dimensional scene graph in which the node of the center and the node of the virtual camera are connected by an edge having a label “behind”, and the node of the virtual camera and the node of the table are connected by an edge having a label “look at”.

A path including the anchor points a0 to a7 is a virtual camera viewpoint path satisfying the measurement scenario of “move from near the entrance (door) of the room to the center of the room and then approach the table”. For example, a plurality of such virtual camera viewpoint paths is generated as candidates.

As described above, the virtual camera viewpoint path is set by adaptively converting coordinates on the basis of a three-dimensional scene graph and using the coordinates, instead of directly using the camera viewpoint path of the task space. The coordinates are converted such that a point on the virtual space having context information common to the context information at each viewpoint included in the camera viewpoint path of the task space is set as the virtual camera viewpoint.

Since the coordinates are adaptively converted on the basis of a three-dimensional scene graph, alignment between the task space and the virtual space becomes unnecessary. The user does not need to arrange a virtual object in the virtual space so as to have the same relationship as a relationship of a real object in the task space.

In step S14, the virtual camera viewpoint path generation unit 34 three-dimensionally interpolates virtual camera viewpoints generated discretely as necessary. As a result, the generation of the virtual camera viewpoint path based on the context information (step S6 in FIG. 4) ends.

### <Step S7: Validity Determination and Adjustment of Virtual Camera Viewpoint Path>

In step S7 of FIG. 4, the virtual camera control unit 35 determines whether or not the virtual camera viewpoint path generated by the virtual camera viewpoint path generation unit 34 is valid. Whether or not the virtual camera viewpoint path is valid is determined, for example, by the user qualitatively evaluating information about a path presented on an interface (display).

Scoring based on context information represented by a three-dimensional scene graph may be performed on the virtual camera viewpoint path, and whether or not the virtual camera viewpoint path is valid may be automatically determined on the basis of a scoring result.

For example, scoring is performed on each anchor point of the virtual camera viewpoint path by allocating a higher score as a common degree of context information of an anchor point of the virtual camera viewpoint path is higher with respect to context information of an anchor point of the camera viewpoint path. Furthermore, a total of scores allocated to the individual anchor points is obtained as the score of the virtual camera viewpoint path.

When the score of the virtual camera viewpoint path is higher than a threshold value, the virtual camera viewpoint path is determined to be valid. Each virtual camera viewpoint is set on the basis of the score allocated to each anchor point.

When the virtual camera viewpoint path is determined to be invalid, the virtual camera viewpoint path is adjusted as necessary. The virtual camera viewpoint path is manually adjusted by the user, for example. When the virtual camera viewpoint path is determined to be invalid, the virtual camera viewpoint path may be resampled, or may be manually set again by the user.

When the virtual camera viewpoint path is determined to be valid, the virtual camera control unit 35 sets the virtual camera at each time on the basis of the virtual camera viewpoint path.

### <Step S8: Rendering of Teacher Image Data>

In step S8, the rendering unit 36 performs rendering according to the virtual camera set by the virtual camera control unit 35, to generate CG image data of the virtual space and label image data. The CG image data and the label image data are generated using individual virtual camera viewpoints included in the virtual camera viewpoint path.

The rendering unit 36 outputs a pair of the CG image data and the label image data as teacher image data. Thereafter, the series of processing of the information processing system 1 ends.

When a plurality of virtual spaces is prepared, the above processing is repeated for each virtual space, for example. A plurality of virtual camera viewpoint paths corresponding to the camera viewpoint path according to one measurement scenario is generated for each virtual space by the virtual camera viewpoint path generation unit 34.

Furthermore, the above processing is repeated every time the camera viewpoint path is generated according to different measurement scenarios.

The above processing makes it possible to set a virtual camera viewpoint path for various virtual spaces having common context information, without requiring strict alignment between the task space and the virtual space. Furthermore, it is possible to reduce work with a burden, such as manual adjustment of the virtual camera viewpoint path.

Moreover, on the basis of one measurement scenario defined by the user, it is possible to set a virtual camera viewpoint path according to the same measurement scenario for various virtual spaces having common context information at least in a part.

That is, it is possible to automatically and efficiently set the virtual camera viewpoint for the virtual space to be used for rendering the teacher CG image data.

### Modifications

The user may set a three-dimensional scene graph first, and the virtual space may be generated so as to satisfy context information represented by the three-dimensional scene graph. In the virtual space, virtual objects are arranged so as to satisfy the context information.

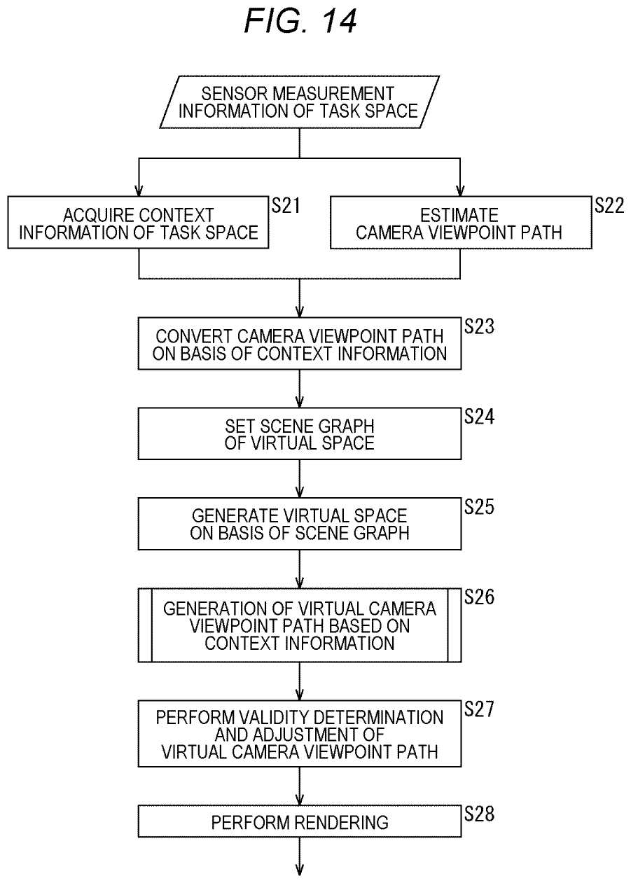

With reference to the flowchart of FIG. 14, processing of the information processing system 1 when the user sets a three-dimensional scene graph first will be described.

The processing illustrated in FIG. 14 is similar to the processing described with reference to FIG. 4 except that a three-dimensional scene graph is set by the user and a virtual space is generated on the basis of the three-dimensional scene graph set by the user.

That is, the three-dimensional scene graph of the task space is generated in step S21, and the camera viewpoint path is estimated in step S22. Furthermore, in step S23, conditioning based on the context information is performed on each anchor point of the camera viewpoint path.

In step S24, the 3D content generation unit 31 sets the three-dimensional scene graph of the virtual space in accordance with an operation by the user.

In step S25, the 3D content generation unit 31 generates the virtual space so as to satisfy the context information represented by the three-dimensional scene graph set by the user.

After the 3D content including the virtual space is generated, processing similar to the processing of steps S6 to S8 of FIG. 4 is performed in steps S26 to S28, respectively. With the above processing, accuracy of the three-dimensional scene graph of the virtual space can be improved.

Although the camera viewpoint path as the conversion source of the virtual camera viewpoint path is assumed to be a path in the real space, a virtual camera viewpoint path in a different virtual space may be generated as the conversion source by using a path set in the virtual space. When the space assumed by the image processing task is a virtual space, the virtual camera viewpoint path is generated using the path set on the virtual space as the conversion source.

### About Program

The series of processing described above can be executed by hardware or by software. When the series of processing is executed by software, a program included in the software is installed from a program recording medium on a computer incorporated in dedicated hardware, a general-purpose personal computer, or the like.

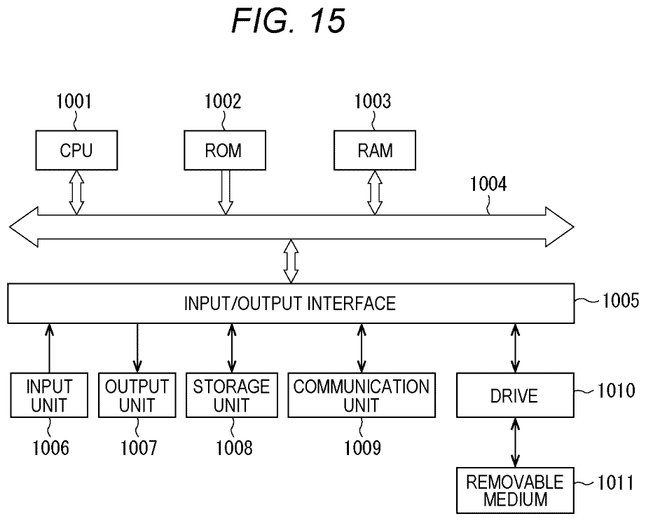

FIG. 15 is a block diagram illustrating a configuration example of hardware of the computer that executes the series of processing described above according to the program.

A central processing unit (CPU) 1001, a read only memory (ROM) 1002, and a random access memory (RAM) 1003 are interconnected via a bus 1004.

An input/output interface 1005 is further connected to the bus 1004. The input/output interface 1005 is connected with an input unit 1006 including, for example, a keyboard and a mouse, and an output unit 1007 including, for example, a display and a speaker. Furthermore, the input/output interface 1005 is connected with a storage unit 1008 including, for example, a hard disk and a non-volatile memory, a communication unit 1009 including, for example, a network interface, and a drive 1010 driving a removable medium 1011.

In the computer configured as described above, for example, the CPU 1001 loads a program stored in the storage unit 1008 into the RAM 1003 via the input/output interface 1005 and the bus 1004 and executes the program to perform the above-described series of processing.

For example, the program to be executed by the CPU 1001 is recorded in the removable medium 1011 or provided via a wired or wireless transmission medium such as a local area network, the Internet, or a digital broadcast, and installed in the storage unit 1008.

Note that the program executed by the computer may be a program that performs processing in a time series according to an order described in the present specification, or may be a program that performs processing in parallel or at necessary timing such as when a call is made.

In the present specification, a system means a set of a plurality of components (devices, modules (parts), and the like), and it does not matter whether or not all the components are in the same housing. Thus, a plurality of devices housed in different housings and connected together via a network and one device in which a plurality of modules is stored in one housing are both systems.

The effects described in the present specification are merely examples and are not restrictive, and other effects may also be produced.

An embodiment of the present technology is not limited to the embodiment described above, and various modifications can be made without departing from the scope of the present technology. For example, the present technology may be embodied in cloud computing in which a function is shared and executed by a plurality of devices via a network.

Furthermore, each step described in the flowchart described above can be performed by one device or can be shared and performed by a plurality of devices.

Moreover, when a plurality of pieces of processing is included in one step, the plurality of pieces of processing included in the one step can be executed by one device or executed by a plurality of devices in a shared manner.

### <Combination Example of Configuration>

The present technology can also have the following configurations.
(1)

An information processing device including:
a generation unit configured to generate a virtual viewpoint path that is a path including a plurality of viewpoints of a virtual camera on the basis of context information of a space, the context information being represented by a three-dimensional scene graph; and
a rendering unit configured to perform rendering of a virtual space at each viewpoint included in the virtual viewpoint path, to generate teacher image data to be used for learning of a machine learning model.
(2)

The information processing device according to (1) above, further including:
an estimation unit configured to estimate a real viewpoint path that is a path including a plurality of viewpoints in a real space, in which
the generation unit generates the virtual viewpoint path corresponding to the real viewpoint path, on the basis of the context information of the real space and the context information of the virtual space.
(3)

The information processing device according to (2) above, in which
the generation unit generates the virtual viewpoint path, on the basis of the context information of the virtual space and the context information of the real space at each viewpoint included in the real viewpoint path.
(4)

The information processing device according to (2) or (3) above, in which
the estimation unit estimates the real viewpoint path on the basis of sensor data obtained by measurement performed in the real space in accordance with a measurement scenario.
(5)

The information processing device according to any one of (2) to (4), further including:
a virtual space information processing unit configured to generate the context information of the virtual space on the basis of three-dimensional data of the virtual space and label information of a virtual object arranged in the virtual space.
(6)

The information processing device according to (3) above, further including:
a path converting unit configured to set the context information represented by using a partial graph in an entire three-dimensional scene graph representing the context information of the real space, as the context information of each viewpoint included in the real viewpoint path.
(7)

The information processing device according to (6) above, in which
the generation unit sets, as a viewpoint of the virtual camera, a point on the virtual space having the context information common to the context information of the real space at each viewpoint included in the real viewpoint path, and the generation unit generates the virtual viewpoint path.
(8)

The information processing device according to (7) above, in which
the generation unit sets a viewpoint of the virtual camera, on the basis of a score indicating a common degree of the context information of the virtual space with respect to the context information of the real space.
(9)

The information processing device according to any one of (2) to (8) above, in which
the generation unit generates a plurality of the virtual viewpoint paths individually in a plurality of the virtual spaces, the plurality of the virtual viewpoint paths corresponding to the real viewpoint path whose number is one.
(10)

The information processing device according to any one of (2) to (9) above, in which
the context information of the real space is represented by a three-dimensional scene graph in which at least an object arranged in the real space is represented with a node and a relative relationship between nodes is represented with an edge, and
the context information of the virtual space is represented by a three-dimensional scene graph in which at least a virtual object arranged in the virtual space is represented with a node and a relative relationship between nodes is represented with an edge.
(11)

The information processing device according to any one of (2) to (10) above, in which
the real space and the virtual space are spaces having different pieces of the context information.
(12)

An information processing method causing an information processing device to execute processing including:
generating a virtual viewpoint path that is a path including a plurality of viewpoints of a virtual camera on the basis of context information of a space, the context information being represented by a three-dimensional scene graph; and
rendering a virtual space at each viewpoint included in the virtual viewpoint path, to generate teacher image data to be used for learning of a machine learning model.
(13)

A program for causing a computer to execute processing including:
generating a virtual viewpoint path that is a path including a plurality of viewpoints of a virtual camera on the basis of context information of a space, the context information being represented by a three-dimensional scene graph; and
rendering a virtual space at each viewpoint included in the virtual viewpoint path, to generate teacher image data to be used for learning of a machine learning model.

### REFERENCE SIGNS LIST

1 Information processing system
11 Teacher image data generation device
12 Task space information processing device
13 Measurement sensor
21 Camera viewpoint path estimation unit
22 Path converting unit
23 GUI processor
24 Image generation unit
31 3D content generation unit
32 Label information generation unit
33 Virtual space information processing unit
34 Virtual camera viewpoint path generation unit
35 Virtual camera control unit
36 Rendering unit
51 Task space information processing unit

1. An information processing device comprising:
a generation unit configured to generate a virtual viewpoint path that is a path including a plurality of viewpoints of a virtual camera on the basis of context information of a space, the context information being represented by a three-dimensional scene graph; and
a rendering unit configured to perform rendering of a virtual space at each viewpoint included in the virtual viewpoint path, to generate teacher image data to be used for learning of a machine learning model.

2. The information processing device according to claim 1, further comprising:
an estimation unit configured to estimate a real viewpoint path that is a path including a plurality of viewpoints in a real space, wherein
the generation unit generates the virtual viewpoint path corresponding to the real viewpoint path, on a basis of the context information of the real space and the context information of the virtual space.

3. The information processing device according to claim 2, wherein
the generation unit generates the virtual viewpoint path, on a basis of the context information of the virtual space and the context information of the real space at each viewpoint included in the real viewpoint path.

4. The information processing device according to claim 2, wherein
the estimation unit estimates the real viewpoint path on a basis of sensor data obtained by measurement performed in the real space in accordance with a measurement scenario.

5. The information processing device according to claim 2, further comprising:
a virtual space information processing unit configured to generate the context information of the virtual space on a basis of three-dimensional data of the virtual space and label information of a virtual object arranged in the virtual space.

6. The information processing device according to claim 3, further comprising:
a path converting unit configured to set the context information represented by using a partial graph in an entire three-dimensional scene graph representing the context information of the real space, as the context information of each viewpoint included in the real viewpoint path.

7. The information processing device according to claim 6, wherein
the generation unit sets, as a viewpoint of the virtual camera, a point on the virtual space having the context information common to the context information of the real space at each viewpoint included in the real viewpoint path, and the generation unit generates the virtual viewpoint path.

8. The information processing device according to claim 7, wherein
the generation unit sets a viewpoint of the virtual camera, on a basis of a score indicating a common degree of the context information of the virtual space with respect to the context information of the real space.

9. The information processing device according to claim 2, wherein
the generation unit generates a plurality of the virtual viewpoint paths individually in a plurality of the virtual spaces, the plurality of the virtual viewpoint paths corresponding to the real viewpoint path whose number is one.

10. The information processing device according to claim 2, wherein
the context information of the real space is represented by a three-dimensional scene graph in which at least an object arranged in the real space is represented with a node and a relative relationship between nodes is represented with an edge, and
the context information of the virtual space is represented by a three-dimensional scene graph in which at least a virtual object arranged in the virtual space is represented with a node and a relative relationship between nodes is represented with an edge.

11. The information processing device according to claim 2, wherein
the real space and the virtual space are spaces having different pieces of the context information.

12. An information processing method causing an information processing device to execute processing comprising:
generating a virtual viewpoint path that is a path including a plurality of viewpoints of a virtual camera on a basis of context information of a space, the context information being represented by a three-dimensional scene graph; and
rendering a virtual space at each viewpoint included in the virtual viewpoint path, to generate teacher image data to be used for learning of a machine learning model.

13. A program for causing a computer to execute processing comprising:
generating a virtual viewpoint path that is a path including a plurality of viewpoints of a virtual camera on a basis of context information of a space, the context information being represented by a three-dimensional scene graph; and
rendering a virtual space at each viewpoint included in the virtual viewpoint path, to generate teacher image data to be used for learning of a machine learning model.
